(19) United States
(12) Patent Application Publication
(10) Pub. No.: US 2024/0215752 A1
(43) Pub. Date: Jul. 4, 2024

(54) BEVERAGE-MAKING MACHINE WITH ILLUMINATED BREW BASKET FOR MEASURING LOOSE GROUNDS

(71) Applicant: Hamilton Beach Brands, Inc., Glen Allen, VA (US)

(72) Inventor: Patrick Walraven, Glen Allen, VA (US)

(21) Appl. No.: 18/092,265

(22) Filed: Dec. 31, 2022

(51) Int. Cl. A47J 31/44; A47J 31/057

(52) U.S. Cl. CPC A47J 31/446; A47J 31/0573; A47J 31/4407; A47J 31/4475; A47J 31/06

(57) ABSTRACT

A beverage maker includes: a housing having a platform, a tower mounted to and extending upwardly from the platform, and a basket holder extending generally horizontally from the tower and over the platform; a brew basket positioned in the basket holder; a fluid reservoir mounted to the housing; a heating unit; a fluid outlet positioned over the brew basket; piping fluidly connecting the fluid reservoir with the fluid outlet, the piping routed adjacent the heating unit; and a brew filter positioned in the brew basket, the brew filter being formed of a permeable material. The brew filter includes a first transparent window and the brew basket includes a second transparent window. An illuminating unit is positioned in the basket holder. The first and second transparent windows are positioned so that light from the illuminating unit passes through the first and second windows.

### FIELD OF THE INVENTION

The present invention relates generally to small appliances, and more specifically to beverage makers.

### BACKGROUND

Automatic drip coffeemakers are well known and widely used. They are effective to brew carafes of coffee, typically containing five to eight cups or more of liquid. Automatic drip coffee makers may also be used for brewing small batches (one to four cups).

A typical automatic drip coffeemaker includes a brew basket that contains ground coffee (presented loosely in a bowl-shaped filter, in a sealed packet, or within a “pod”-type package). Heated water is conveyed to the brew basket and released, where it gravimetrically flows downwardly through the coffee grounds and into a receptacle such as a carafe or pot. Exemplary automatic drip coffeemakers are discussed in U.S. Pat. No. 5,001,969 to Moore et al.; U.S. Pat. No. 7,066,080 to Hsu; and U.S. Pat. No. 8,065,952 to Wang, the disclosures of which are hereby incorporated herein by reference in full. Some coffeemakers are designed to brew coffee in different forms; for example, coffeemakers offered in the FLEXBREW® line of products available from Hamilton Beach Brands (Richmond, Virginia) include an insert that enables the user to choose between a pod or loose ground coffee.

Moreover, another coffeemaker offered in the FLEXBREW® line of coffeemakers has two different “stations,” one of which can brew a full pot or carafe, and the other of which brews a single serving (often utilizing a pod as described above). This coffeemaker can provide the user with the flexibility of brewing either a single serving, if that is all that is desired, or multiple servings in a pot or carafe.

It may be desirable to provide performance improvements to coffeemakers, and in particular coffeemakers that brew loose grounds.

### SUMMARY

As a first aspect, embodiments of the invention are directed to a beverage maker. The beverage maker comprises: a housing having a platform, a tower mounted to and extending upwardly from the platform, and a basket holder fixed to and extending generally horizontally from the tower and over the platform; a brew basket positioned in the basket holder; a fluid reservoir mounted to the housing; a heating unit; a fluid outlet positioned over the brew basket; piping fluidly connecting the fluid reservoir with the fluid outlet, the piping routed adjacent the heating unit to permit the heating unit to heat fluid in piping as it travels from the fluid reservoir to the fluid outlet; and a brew filter positioned in the brew basket, the brew filter being formed of a permeable material. The brew filter includes a first transparent window, and the brew basket includes a second transparent window. An illuminating unit is positioned in the basket holder. The first and second transparent windows are positioned so that light from the illuminating unit passes through the first and second windows.

As a second aspect, embodiments of the invention are directed to a beverage maker comprising: a housing having a platform, a tower mounted to and extending upwardly from the platform, and a basket holder fixed to and extending generally horizontally from the tower and over the platform; a fluid reservoir mounted to the housing; a heating unit; a fluid outlet positioned over the basket holder; piping fluidly connecting the fluid reservoir with the fluid outlet, the piping routed adjacent the heating unit to permit the heating unit to heat fluid in piping as it travels from the fluid reservoir to the fluid outlet; and a brew filter positioned in the basket holder, the brew filter being formed of a permeable material. The brew filter includes a transparent window, the window including markings corresponding to a level of material contained in the brew filter. An illuminating unit is positioned in the basket holder. The transparent window is positioned so that light from the illuminating unit passes therethrough.

As a third aspect, embodiments of the invention are directed to a beverage maker comprising: a housing having a platform, a tower mounted to and extending upwardly from the platform, and a basket holder fixed to and extending generally horizontally from the tower and over the platform; a fluid reservoir mounted to the housing; a heating unit; a fluid outlet positioned over the basket holder; piping fluidly connecting the fluid reservoir with the fluid outlet, the piping routed adjacent the heating unit to permit the heating unit to heat fluid in piping as it travels from the fluid reservoir to the fluid outlet; and a brew filter positioned in the basket holder, the brew filter being formed of a permeable material. The brew filter includes a transparent window. An illuminating unit is positioned in the basket holder. The transparent window is positioned so that light from the illuminating unit passes therethrough. The beverage maker further comprises a controller operatively connected with the illuminating unit, wherein the controller activates the illuminating unit based on an action taken by a user of the beverage maker.

### BRIEF DESCRIPTION OF THE FIGURES

FIG. 1 is a front perspective view of a beverage maker according to embodiments of the invention.

FIG. 2 is a rear perspective view of the beverage maker of FIG. 1.

FIG. 3 is a side section view of the beverage maker of FIG. 1.

FIG. 4 is an enlarged, partial side section view of the basket holder of the beverage maker of FIG. 1 that illustrates the shower arm

FIG. 5 is a top section view of the shower arm and lower portion of the lid of the beverage maker of FIG. 1.

FIG. 6 is a side section view of the basket holder of FIG. 5 illustrating the brew basket, the brew filter, and the illuminating unit.

FIG. 7 is a top perspective view of the brew filter of the beverage maker of FIG. 1.

FIG. 8 is a top perspective view of the brew basket of the beverage maker of FIG. 1.

FIG. 9 is a top perspective view of the brew filter and brew basket of the beverage maker of FIG. 1.

FIG. 10 is a greatly enlarged partial side section view of the brew filter, brew basket and illuminating unit of the beverage maker of FIG. 10.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

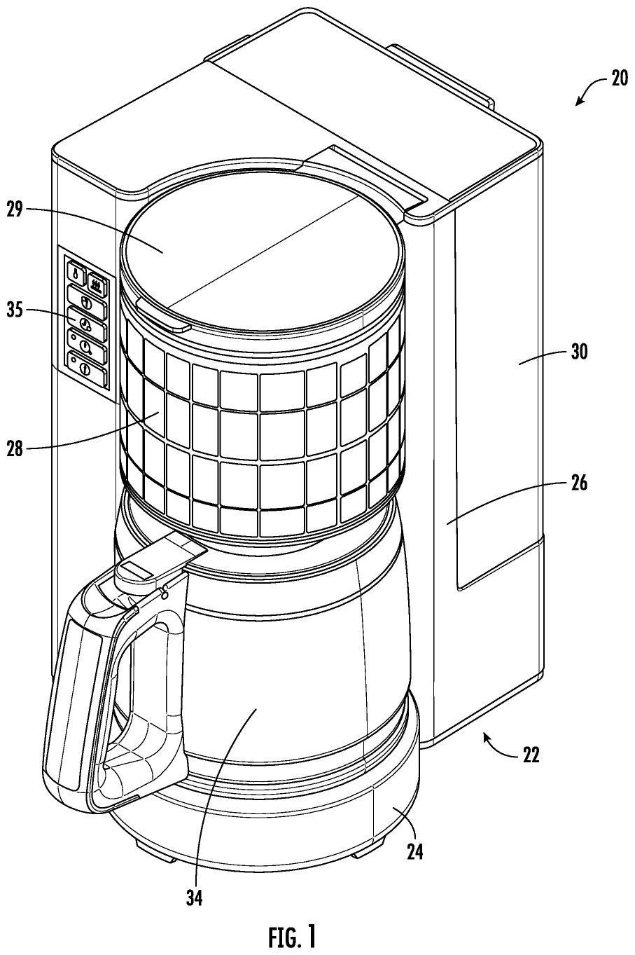

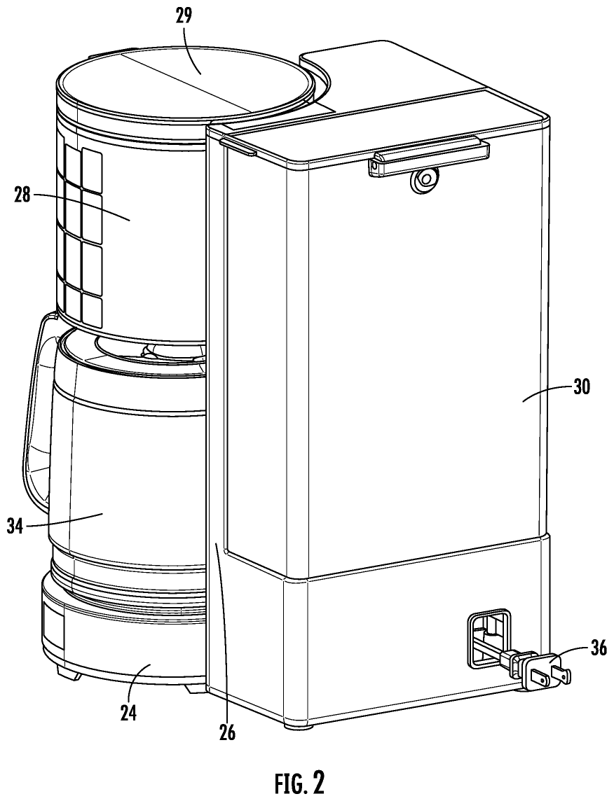

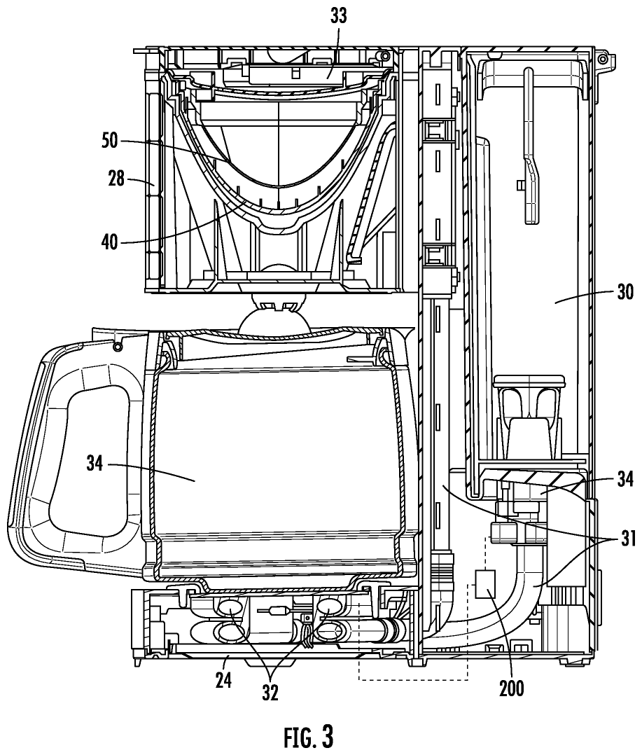

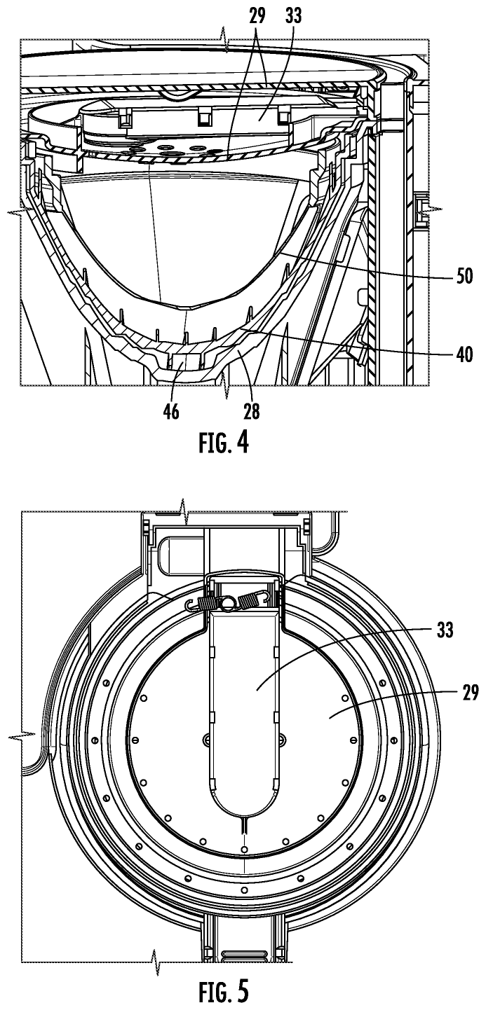

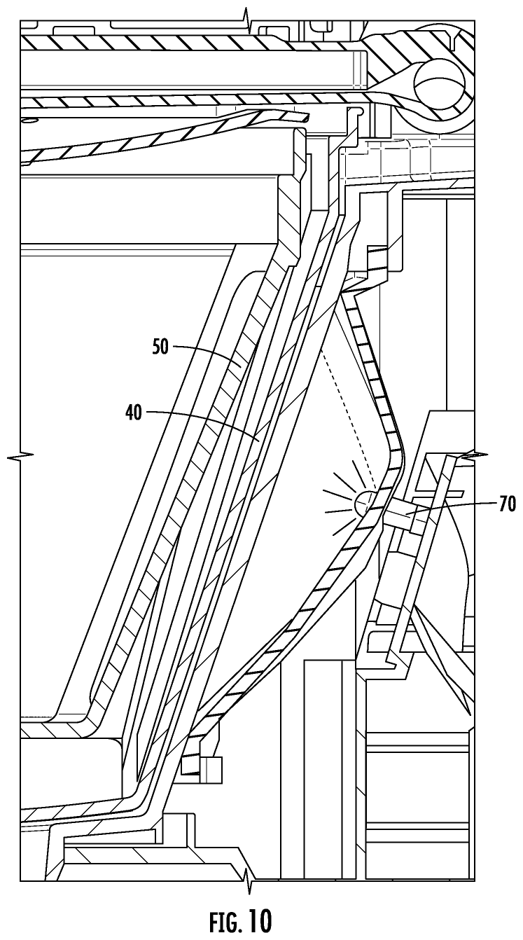

Referring now to the drawings, a beverage maker according to embodiments of the invention is illustrated in FIGS. 1-10 and designated broadly at 20. Generally, the beverage maker 20 includes an overall housing 22 that has a platform 24, a vertical tower 26 that rises from the rear end of the platform 24, and a basket holder 28 that extends forwardly from the upper end of the tower 26. A lid 29 is pivotally attached to the tower 26 and covers the basket holder 28. A water tank 30 is mounted to the rear portion of the housing 22.

As is conventional for beverage makers of this general configuration, the beverage maker 20 includes piping 31 that is routed from the bottom of the water tank 30, below the platform 24 (where it is heated by a heating element 32 positioned directly under the platform 24), and upwardly to a shower arm 33. The shower arm 33, which is located predominantly in the lid 29, extends over the upper portion of the basket holder 28 to provide water that flows through grounds in a brew basket 40 positioned in the basket holder 28. Brewed beverage flows from the bottom of the brew basket 40 through an aperture in the floor of the basket holder 28 and into a vessel, such as a coffee pot 34, where it is collected until brewing is complete. A pump 34 is associated with the piping 31 to draw the water from the water tank 30 to the shower arm 33.

The pump 34 and the heating element 32 are operatively connected with a controller 200, which is also connected with selection buttons 35 on the front face of the tower 26. The controller 200 is also operatively connected with a power cord 36 for connecting the beverage maker 20 with an electrical outlet.

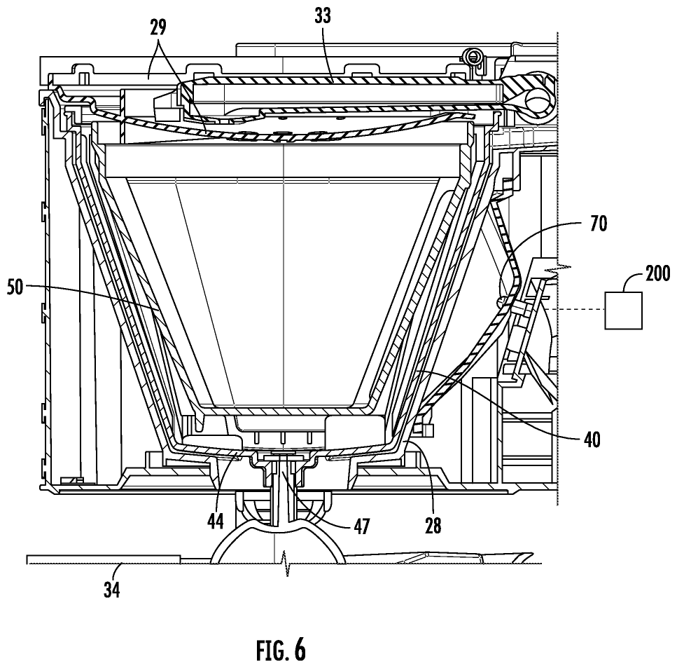

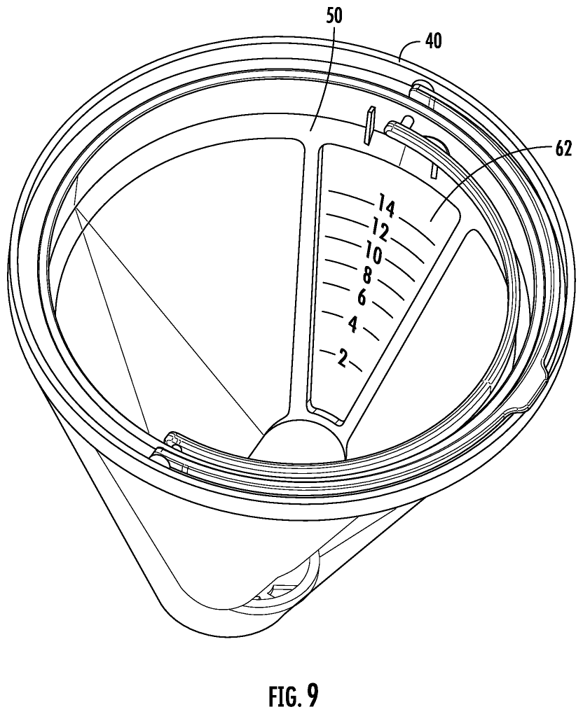

Referring now to FIG. 8, the brew basket 40 is shown therein. The brew basket 40 is generally funnel-shaped; the brew basket 40 has a circular, open upper end 42 and tapers to a narrower lower end 44 that is somewhat oblong. An aperture 46 is present at the lower end 44 and provides an outlet for brewed beverage. A spring-loaded valve 47 (see FIG. 6) is mounted at the lower end 44 and is configured to selectively permit passage of brewed beverage from the brew basket 40 to the pot 34.

In addition, a tall, narrow transparent window 48 is present in the wall of the brew basket 40. The window 48 is generally trapezoidal but could be any number of shapes. The window 48 is typically formed of a clear plastic material, such as polystyrene.

The brew basket 40, which is typically formed of a polymeric material, is removable from the basket holder 28 for cleaning. The oblong shape of the lower end 44 of the brew basket 40 helps to orient the brew basket 40 correctly within the basket holder 28.

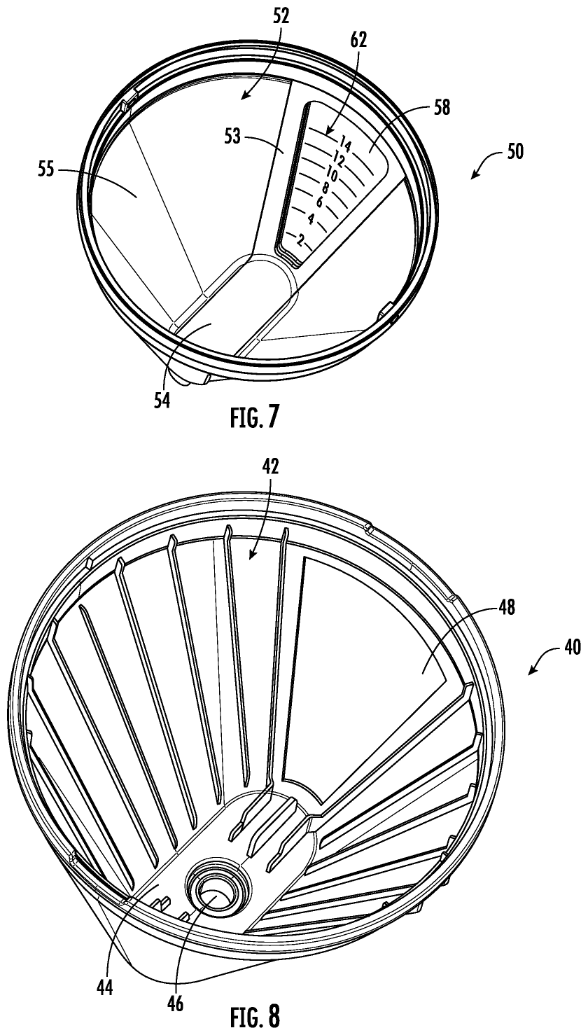

A brew filter 50 (see FIG. 7) resides in the brew basket 40. Like the brew basket 40, the brew filter 50 is generally funnel-shaped, within a circular, open upper end 52 and an oblong lower end 54. The brew filter 50 has a skeletal framework 53 on which is attached a permeable filter material 55 (typically formed of a stainless steel or nylon mesh, which may have gold coating or plating for improved flavor) that can permit the passage of brewed beverage but prevent the passage of grounds.

Like the brew basket 40, the brew filter 50 includes a transparent window 58. The window 58 may be generally similar in shape to the window 48. The window 48 may be formed of the same material as the filter material 55, or may be formed of a different transparent material, such as polystyrene.

In the illustrated embodiment, the window 58 includes graduated markings or indicator lines 62 (see FIG. 7). The markings 62 are positioned to indicate the amount of loose coffee grounds that should be included in the brew filter 50 for a desired amount of coffee. For example, the markings 62 may be included in “2-cup” increments (e.g., 2 cups, 4 cups, 6 cups, etc.) that correspond to standard “cups” of coffee (typically 5 ounces).

The markings 62 can help to address a common issue when preparing coffee or other beverages with loose grounds. In many instances ground coffee is provided in a can, jar or bag, or may even be provided in the form of full beans that are freshly ground by the user prior to brewing. In these situations, often the ground coffee is not provided with a measuring device (e.g., a scoop). The markings 62 can provide an easy and convenient guide to the user as to how full of ground coffee the brew filter 50 should be for the brewing of a desired amount of coffee.

Referring now to FIGS. 6 and 10, the beverage maker 20 may also include an illuminating unit 70 (e.g., a light bulb, LED, or the like) that is mounted in the housing 22 in a position to illuminate the markings 62 in the brew filter 50 through the windows 48, 58. As one example, the illuminating unit 70 may be located within the basket holder 28. The illuminating unit 70 can provide backlit illumination for the markings 62 to enhance the user's view of the markings 62 during filling of the brew filter 50 with coffee grounds or other material for brewing. Such illumination can be particularly helpful if the beverage maker 20 is located in a poorly lit area, or if when the lid 29 of the basket holder 28 is opened, it blocks external illumination. Thus, with the assistance of the illuminating unit 70, the user can easily discern how full the brew filter 50 is, and therefore can more consistently fill the brew filter with the proper amount of loose grounds.

The illuminating unit 70 may be connected to the controller 200, which may control when the illuminating unit 70 is illuminated. For example, the illuminating unit 70 may be illuminated as a response to an action taken by the user. As one example, the illuminating unit 70 may be deactivated until the lid 29 is opened (e.g., the beverage maker 20 may include a sensor connected with the controller 200 that senses when the lid 29 is open), at which point the illuminating unit 70 may remain illuminated for a set period of time (e.g., 2 minutes) to allow the user to more easily fill the brew filter 50 with grounds. Alternatively, the illuminating unit 70 may remain illuminated when the lid 29 is open and may be deactivated when the lid 29 is closed. In some embodiments, the illuminating unit 70 may remain illuminated at all times that the beverage maker 20 is plugged into an electrical outlet or may illuminate when the unit is powered on. Other variations may also be employed.

Those of skill in this art will appreciate that different aspects of the beverage maker may take different forms. As one example, while the markings 62 are shown as graduated numbered lines, in other embodiments the markings may be a pictorial representation (e.g., two cups shown for the two-cup level, four cups shown for the four-cup level, etc., or may include printed text (e.g., “TWO CUPS”). Also, although the markings 62 are shown herein as appearing on the brew filter 50, in some embodiments the markings 62 may appear on the brew basket 40. Other possibilities may also be suitable.

In additional embodiments, the configuration of the beverage maker 20 itself may be different. For example, although a multi-serving beverage maker is shown herein, the beverage maker may also take the form of a multi-station beverage maker such as the FLEXBREW system described above, wherein the device includes both a single-serving station and a multi-serving station that can brew beverages using loose grounds. Also, the arrangement of the water tank 30, piping 31, pump 31 (if any) and heating element(s) may be varied considerably in other embodiments. Further, while in the illustrated embodiment the brew basket 40 and brew filter 50 are accessed by pivoting the lid 29 to a raised position, in other embodiments the basket holder 28, brew basket 40 and brew filter 50 may be pivotally attached to the remainder of the housing, such that they pivot about a vertical axis away from the shower arm to provide access to the brew filter 50 and brew basket 40. Moreover, in some embodiments the brew basket 40 itself may be omitted, such that the brew filter 50 resides directly in the basket holder 28. Other variations may also be suitable for use herein.

Some embodiments of the present invention are exemplarily described above in combination with the accompanying drawings. Those of ordinary skill in the art to which the present invention belongs should understand that specific structures shown in the above embodiments are merely exemplary, rather than limiting. Moreover, those of ordinary skill in the art to which the present invention belongs can combine a variety of technical features shown above according to a variety of possible manners to constitute new technical solutions or make other modifications, and these new technical solutions are encompassed within the scope of the present invention.

That which is claimed is:

1. A beverage maker, comprising:
a housing having a platform, a tower mounted to and extending upwardly from the platform, and a basket holder fixed to and extending generally horizontally from the tower and over the platform;
a brew basket positioned in the basket holder;
a fluid reservoir mounted to the housing;
a heating unit;
a fluid outlet positioned over the brew basket;
piping fluidly connecting the fluid reservoir with the fluid outlet, the piping routed adjacent the heating unit to permit the heating unit to heat fluid in piping as it travels from the fluid reservoir to the fluid outlet;
a brew filter positioned in the brew basket, the brew filter being formed of a permeable material;
wherein the brew filter includes a first transparent window and the brew basket includes a second transparent window;
wherein an illuminating unit is positioned in the basket holder; and
wherein the first and second transparent windows are positioned so that light from the illuminating unit passes through the first and second windows.

2. The beverage maker defined in claim 1, wherein one of the first and second windows includes markings corresponding to a level of material contained in the brew filter.

3. The beverage maker defined in claim 2, wherein the markings comprise graduated numbered lines.

4. The beverage maker defined in claim 1, further comprising a lid that covers the basket holder, wherein when the lid is moved to an open position that permits a user access to the brew filter.

5. The beverage maker defined in claim 4, wherein the fluid outlet is located on a shower arm, and wherein the shower arm is positioned at least partially within the lid.

6. The beverage maker defined in claim 1, further comprising a controller, and wherein the illuminating unit is operatively connected to the controller.

7. The beverage maker defined in claim 6, further comprising a lid that covers the basket holder, and wherein the controller is configured to activate the illuminating unit when the lid is moved to an open position that permits a user access to the brew filter.

8. The beverage maker defined in claim 1, wherein the illuminating unit is a light emitting diode (LED).

9. A beverage maker, comprising:
a housing having a platform, a tower mounted to and extending upwardly from the platform, and a basket holder fixed to and extending generally horizontally from the tower and over the platform;
a fluid reservoir mounted to the housing;
a heating unit;
a fluid outlet positioned over the basket holder;
piping fluidly connecting the fluid reservoir with the fluid outlet, the piping routed adjacent the heating unit to permit the heating unit to heat fluid in piping as it travels from the fluid reservoir to the fluid outlet;
a brew filter positioned in the basket holder, the brew filter being formed of a permeable material;
wherein the brew filter includes a transparent window, the window including markings corresponding to a level of material contained in the brew filter;
wherein an illuminating unit is positioned in the basket holder;
wherein the transparent window is positioned so that light from the illuminating unit passes therethrough.

10. The beverage maker defined in claim 9, wherein the markings comprise graduated numbered lines.

11. The beverage maker defined in claim 9, further comprising a lid that covers the basket holder, wherein when the lid is moved to an open position that permits a user access to the brew filter.

12. The beverage maker defined in claim 11, wherein the fluid outlet is located on a shower arm, and wherein the shower arm is positioned at least partially within the lid.

13. The beverage maker defined in claim 9, further comprising a controller, and wherein the illuminating unit is operatively connected to the controller.

14. The beverage maker defined in claim 13, further comprising a lid that covers the basket holder, and wherein the controller is configured to activate the illuminating unit when the lid is moved to an open position that permits a user access to the brew filter.

15. The beverage maker defined in claim 9, wherein the illuminating unit is a light emitting diode (LED).

16. A beverage maker, comprising:
a housing having a platform, a tower mounted to and extending upwardly from the platform, and a basket holder fixed to and extending generally horizontally from the tower and over the platform;
a fluid reservoir mounted to the housing;
a heating unit;
a fluid outlet positioned over the basket holder;
piping fluidly connecting the fluid reservoir with the fluid outlet, the piping routed adjacent the heating unit to permit the heating unit to heat fluid in piping as it travels from the fluid reservoir to the fluid outlet;
a brew filter positioned in the basket holder, the brew filter being formed of a permeable material;
wherein the brew filter includes a transparent window;
wherein an illuminating unit is positioned in the basket holder;
wherein the transparent window is positioned so that light from the illuminating unit passes therethrough; and
wherein the beverage maker further comprises a controller operatively connected with the illuminating unit, and wherein the controller activates the illuminating unit based on an action taken by a user of the beverage maker.

17. The beverage maker defined in claim 16, further comprising a lid that covers the basket holder, and wherein the controller is configured to activate the illuminating unit when the lid is moved to an open position that permits a user access to the brew filter.

18. The beverage maker defined in claim 16, wherein the window includes markings corresponding to a level of material contained in the brew filter.

19. The beverage maker defined in claim 18, wherein the markings comprise graduated numbered lines.
